(19) United States
(12) Patent Application Publication
(10) Pub. No.: US 2026/0039734 A1
(43) Pub. Date: Feb. 5, 2026

(54) ELECTRONIC APPARATUS

(71) Applicant: Samsung Display Co., LTD., Yongin-si (KR)

(72) Inventors: Byungcheol AHN, Yongin-si (KR); DASOM GU, Yongin-si (KR); KYUNGTAE KIM, Yongin-si (KR); DOHOON KIM, Yongin-si, Gyeonggi-do (KR); SANG-IL PARK, Yongin-si (KR); SUNGGUK AN, Yongin-si (KR)

(21) Appl. No.: 19/265,776

(22) Filed: Jul. 10, 2025

(30) Foreign Application Priority Data
Aug. 2, 2024 (KR) 10-2024-0103152

(51) Int. Cl. H04M 1/02

(52) U.S. Cl. CPC H04M 1/0268; H04M 1/0216

(57) ABSTRACT

Provided is an electronic apparatus including an electronic panel including a light-emitting element and foldable with respect to a folding axis extending along a first direction, and a window member disposed on the electronic panel and foldable with respect to the folding axis. The window member includes a first hard film disposed on an uppermost part, a soft film disposed between the first hard film and the electronic panel and having a modulus lower than a modulus of the first hard film, and a second hard film disposed between the first hard film and the electronic panel and having a modulus higher than a modulus of the soft film. The soft film has a recovery rate of about 90% or more.

This application claims priority to Korean Patent Application No. 10-2024-0103152, filed on Aug. 2, 2024, and all the benefits accruing therefrom under 35 U.S.C. § 119, the content of which in its entirety is herein incorporated by reference.

### BACKGROUND

### Field

The present disclosure herein relates to an electronic apparatus, and more particularly, to a foldable electronic apparatus with improved reliability.

### Description of the Related Art

Bendable or foldable electronic apparatuses are actively being developed. A flexible electronic apparatus may include an electronic panel, such as a flexible display panel or a flexible touch panel, and a window which covers the electronic panel. The window may include various functional layers. The functional layers may be bendable or foldable in conjunction with the electronic panel.

It may be desired for layers constituting the electronic apparatus to have relatively flexible properties for being bent or folded. For some implementations in which the layers have the flexible properties, reliability against a bending stress may be improved, but reliability against an external impact may be deteriorated.

### SUMMARY

The present disclosure provides a foldable electronic apparatus with improved impact resistance and flexibility.

An embodiment of the inventive concept provides an electronic apparatus including: an electronic panel including a light-emitting element and foldable with respect to a folding axis extending along a first direction; and a window member disposed on the electronic panel and foldable with respect to the folding axis, wherein the window member includes a first hard film disposed on an uppermost part of the window member, a soft film disposed between the first hard film and the electronic panel and having a modulus lower than a modulus of the first hard film, and a second hard film disposed between the first hard film and the electronic panel and having a modulus higher than a modulus of the soft film, and the soft film has a recovery rate of about 90% or more.

In an embodiment, a distance between an upper surface of the electronic panel and an upper surface of the first hard film may range from about 300 μm to about 600 μm.

In an embodiment, a thickness of the soft film may be greater than a thickness of the second hard film.

In an embodiment, the second hard film may be disposed between the soft film and the electronic panel.

In an embodiment, the second hard film may be disposed between the soft film and the first hard film.

In an embodiment, the first hard film may have a thickness of about 75 μm.

In an embodiment, the second hard film may have a thickness smaller than the thickness of the first hard film.

In an embodiment, the electronic apparatus may further include a second soft film disposed between the first hard film and the electronic panel.

In an embodiment, the soft film and the second soft film may be bonded with an adhesive layer between the soft film and the second soft film.

In an embodiment, the soft film and the second soft film may be disposed between the first hard film and the second hard film.

In an embodiment, the soft film and the second soft film may be disposed between the electronic panel and the second hard film.

In an embodiment, the electronic apparatus may further include a third hard film disposed between the soft film and the first hard film, wherein the second hard film may be disposed between the soft film and the electronic panel.

In an embodiment, the second hard film may include a thin-glass film.

In an embodiment, the second hard film may be disposed between the soft film and the electronic panel.

In an embodiment, the second hard film may be disposed between the soft film and the first hard film.

In an embodiment, the electronic panel further may include a sensor layer which may detect an external input.

In an embodiment, the second hard film may have a thickness of about 30 μm or more, and the soft film has a thickness of about 50 μm or more.

In an embodiment of the inventive concept, an electronic apparatus includes: an electronic panel including a light-emitting element and foldable with respect to a folding axis extending along a first direction; a lower member disposed between the folding axis and the electronic panel; and a window member disposed on an upper surface of the electronic panel and foldable with respect to the folding axis, wherein the window member includes a first hard film disposed on an uppermost part of the window member, a soft film disposed between the first hard film and the electronic panel and having a modulus lower than a modulus of the first hard film, a second hard film disposed between the first hard film and the soft film and having a modulus higher than a modulus of the soft film, and a plurality of adhesive layers, and the window member has a thickness ranging from about 300 μm to about 600 μm.

In an embodiment, the first hard film may have a high temperature modulus ranging from about 2 GPa to about 10 GPa and a thickness ranging from about 75 μm to about 150 μm, and the soft film may have a high temperature modulus of about 1 GPa or lower, a thickness ranging from about 50 μm about 150 μm, and a recovery force of about 90% or more.

In an embodiment, the first hard film may include a resin film, and the second hard film may include a thin-glass film.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIGS. 1A to 1C are perspective views of a display apparatus according to an embodiment of the inventive concept;

FIGS. 2A and 2B are perspective views of a display apparatus according to an embodiment of the inventive concept;

FIG. 3A is an exploded perspective view of a display apparatus according to an embodiment of the inventive concept;

FIG. 3B is a block diagram of a display apparatus according to an embodiment of the inventive concept;

FIGS. 4A and 4B are cross-sectional views briefly illustrating an electronic apparatus according to an embodiment of the inventive concept;

FIGS. 5A to 5C are cross-sectional views of an electronic apparatus according to embodiments of the inventive concept;

FIGS. 6A to 6D are cross-sectional views of an electronic apparatus according to embodiments of the inventive concept;

FIGS. 7A and 7B are cross-sectional views of an electronic apparatus according to an embodiment of the inventive concept; and

FIGS. 8A and 8B are cross-sectional views of an electronic apparatus according to an embodiment of the inventive concept.

### DETAILED DESCRIPTION

In this specification, it will be understood that when an element (or region, layer, portion, or the like) is referred to as being “on”, “connected to” or “coupled to” another element, it may be directly disposed/connected/coupled to another element, or intervening elements may be disposed therebetween.

Like reference numerals or symbols refer to like elements throughout. In some aspects, in the drawings, the thickness, the ratio, and the dimension of the elements are exaggerated for effective description of the technical contents.

The term “and/or” includes all combinations of one or more of the associated listed elements.

Although the terms first, second, and the like, may be used to describe various elements, these elements should not be limited by these terms. These terms are used to distinguish one element from another element. For example, a first element may be referred to as a second element, and similarly, a second element may also be referred to as a first element without departing from the scope of the inventive concept. The singular forms include the plural forms as well, unless the context clearly indicates otherwise.

In some aspects, the terms such as “below”, “lower”, “above”, “upper” and the like, may be used for the description to describe one element's relationship to another element illustrated in the figures. It will be understood that the terms have a relative concept and are described on the basis of the orientation depicted in the figures.

The terms “about” or “approximately” as used herein are inclusive of the stated value and include a suitable range of deviation for the particular value as determined by one of ordinary skill in the art, considering the measurement in question and the error associated with measurement of the particular quantity. The terms “about” or “approximately” can mean within one or more standard deviations, or within ±30%, 20%, 10%, 5% of the stated value, for example.

The term “substantially,” as used herein, means approximately or actually. The term “substantially equal” means approximately or actually equal. The term “substantially the same” means approximately or actually the same. The term “substantially perpendicular” means approximately or actually perpendicular. The term “substantially parallel” means approximately or actually parallel.

Unless otherwise defined, all terms (including technical and scientific terms) used herein have the same meaning as commonly understood by one of ordinary skill in the art to which the present disclosure belongs. In some aspects, it will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that the term “includes” or “comprises”, when used in this specification, specifies the presence of stated features, integers, steps, operations, elements, components, or a combination thereof, but does not preclude the presence or addition of one or more other features, integers, steps, operations, elements, components, or combinations thereof.

Hereinafter, embodiments of the inventive concept are described with reference to the drawings.

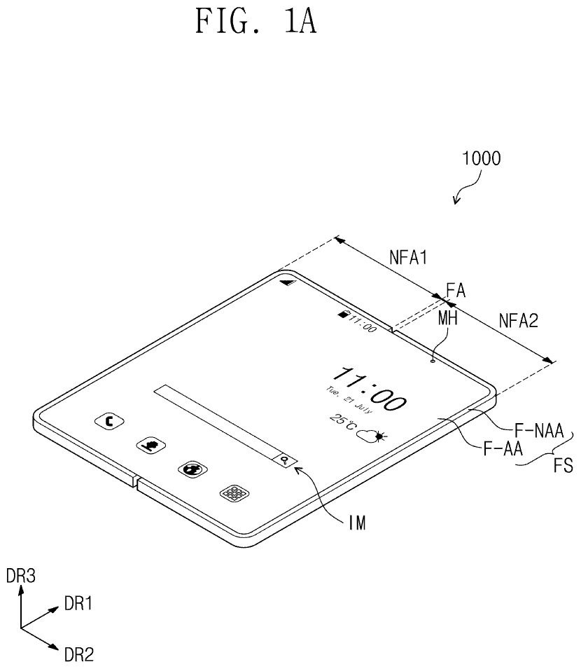

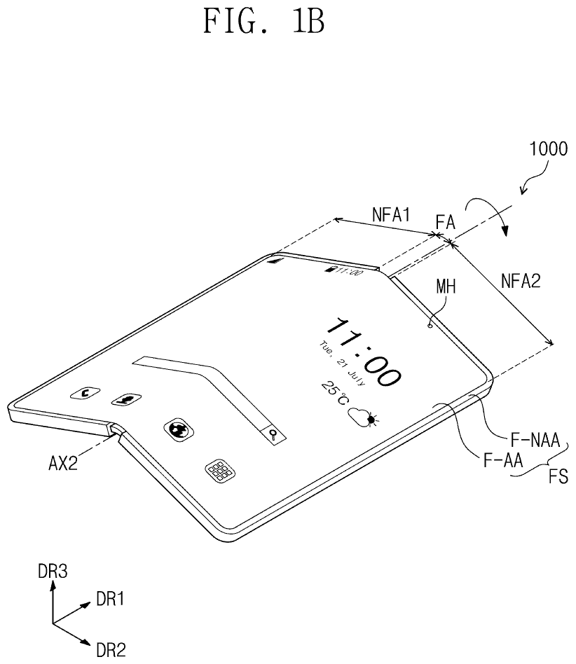

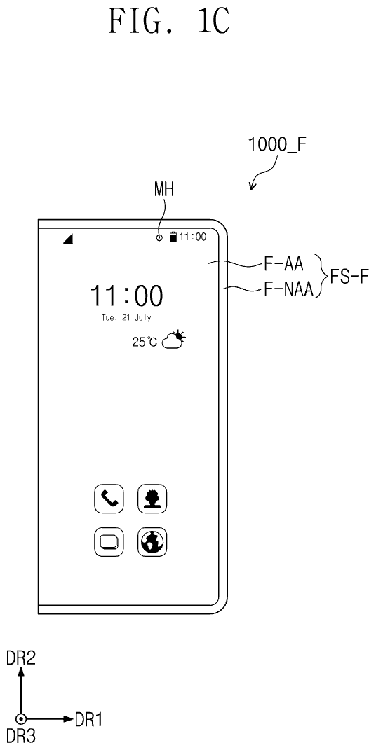

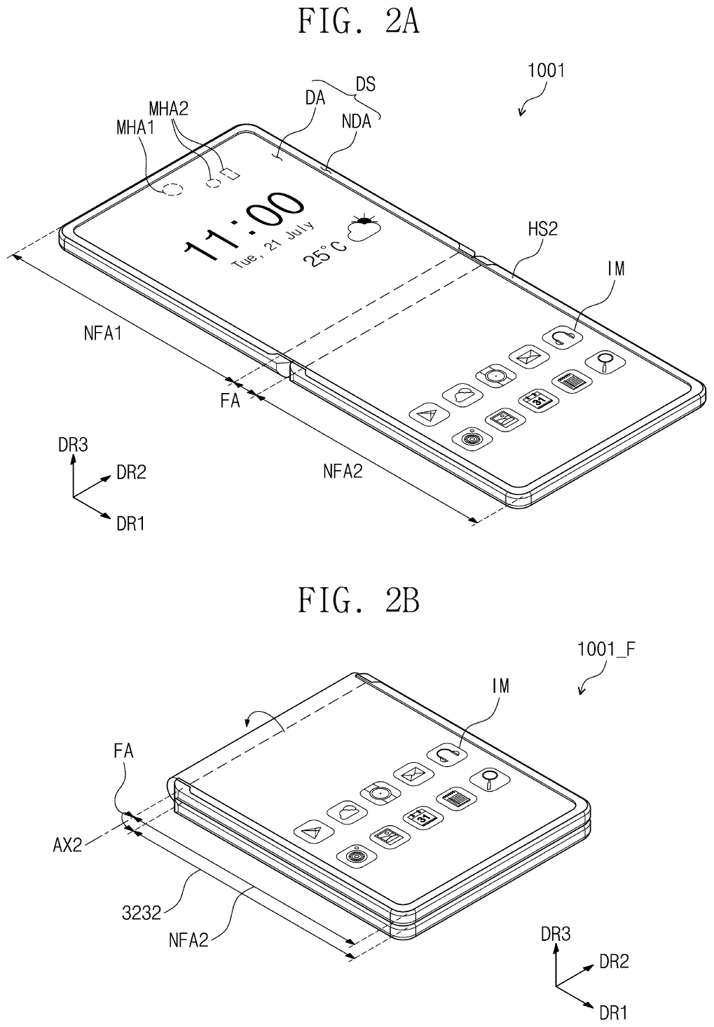

FIGS. 1A to 1C are perspective views of a display apparatus according to an embodiment of the inventive concept. FIGS. 2A and 2B are perspective views of a display apparatus according to an embodiment of the inventive concept. FIG. 1A is a perspective view illustrating a state in which an electronic apparatus 1000 is unfolded, and FIGS. 1B and 1C are perspective views illustrating a state in which the electronic apparatus 1000 illustrated in FIG. 1A is folded. FIG. 2A is a perspective view illustrating a state in which an electronic apparatus 1001 is unfolded, and FIG. 2B is a perspective view illustrating a state in which the electronic apparatus 1001 illustrated in FIG. 2A is folded. Hereinafter, an embodiment of the inventive concept will be described with reference to FIGS. 1A to 2B.

The electronic apparatuses 1000 and 1001 may be activated in response to an electrical signal. The electronic apparatuses 1000 and 1001 may include various embodiments. For example, the electronic apparatuses 1000 and 1001 may include a tablet computer, a laptop computer, a desktop computer, a smart television, etc. In this embodiment, the electronic apparatuses 1000 and 1001 are illustrated as a smart phone as an example, but embodiments of the present disclosure are not limited thereto.

The electronic apparatuses 1000 and 1001 may display an image IM, in a third direction DR3, on a first display surface FS parallel to each of a first direction DR1 and a second direction DR2. The first display surface FS, on which the image IM is displayed, may correspond to a front surface of each of the electronic apparatuses 1000 and 1001. The image IM may include not only a dynamic image but also a static image. In FIGS. 1A to 2B, an internet search bar and a clock display are illustrated as examples of the image IM.

According to this embodiment, in an unfolded state of the electronic apparatuses 1000 and 1001, a front surface (or an upper surface) and a rear surface (or a lower surface) of each component are defined with respect to a direction in which the image IM is displayed. The front surface and the rear surface may be opposed to each other in the third direction DR3, and a normal direction of each of the front surface and the rear surface may be parallel to the third direction DR3.

A spacing distance between the front surface and the rear surface in the third direction DR3 may correspond to a thickness/height of each of the electronic apparatuses 1000 and 1001 in the third direction DR3. Directions indicated as the first to third directions DR1, DR2, and DR3 may have a relative concept, and may thus be changed to other directions.

The electronic apparatuses 1000 and 1001 may detect an external input applied from the outside. The external input may include a user's input. The user's input may include various types of inputs such as, for example, a part of a user's body, an electromagnetic pen, light, heat, or pressure.

For example, the external input may include not only a touch by a part of a user's body such as, for example, a hand, but also an external input (for example, hovering) applied while approaching or being adjacent within a predetermined distance to the electronic apparatuses 1000 and 1001. In some aspects, the external input may have various forms such as, for example, force, pressure, temperature, light, etc. In some aspects, the electronic apparatuses 1000 and 1001 according to the inventive concept may also detect an external input from an electromagnetic pen which generates a magnetic field. Further, the electronic apparatuses 1000 and 1001 may also detect a plurality of inputs different from each other. For example, the electronic apparatuses 1000 and 1001 may also detect the external input from the pen and the external input from the user's hand. Although not illustrated, the electromagnetic pen may be attached to and detached from the inside or outside of the electronic apparatuses 1000 and 1001, and the electronic apparatuses 1000 and 1001 may also provide and receive signals in response to the attachment and detachment of the electromagnetic pen.

Referring to FIG. 1A to 1C, the display surface FS may include a first active region F-AA (an active region) and a first peripheral region F-NAA (a peripheral region). The peripheral region F-NAA is adjacent to the active region F-AA. The peripheral region F-NAA may have a light transmittance lower than a light transmittance of the active region F-AA, and may have a predetermined color.

In this embodiment, a predetermined electronic module region MH may be defined in the display surface FS, but embodiments of the present disclosure are not limited thereto. The electronic module region MH is illustrated as being provided in the active region F-AA, but is not limited thereto, and may also be provided in the peripheral region F-NAA. The electronic module region MH may be a region in which at least one among electronic modules to be described later is disposed. For example, the electronic apparatus 1000 may capture or detect an external subject via the electronic module region MH.

In this embodiment, the peripheral region F-NAA may surround the active region F-AA, but embodiments of the present disclosure are not limited thereto. Accordingly, the shape of the active region F-AA may be substantially defined by the peripheral region F-NAA. However, this is illustrated as an example. The peripheral region F-NAA may not only be disposed adjacent to a single side of the active region F-AA but also be omitted.

The electronic apparatus 1000 according to an embodiment of the inventive concept may be folded with respect to a predetermined folding axis. For example, referring to FIGS. 1B and 1C, an imaginary first folding axis AX1 extending in the first direction DR1 may be defined in the electronic apparatus 1000. The first folding axis AX1 may extend along the first direction DR1 below the display surface FS. The display surface FS of the electronic apparatus 1000 may include a folding region FA which is folded with respect to the first folding axis AX1, and a first non-folding region NFA1 and a second non-folding region NFA2 which are spaced apart from each other in the second direction DR2, with the folding region FA between the first non-folding region NFA1 and the second non-folding region NFA2.

The electronic apparatus 1000 may be folded with respect to the first folding axis AX1 in an outwardly folding manner such that the first non-folding region NFA1 and the second non-folding region NFA2 are folded in directions opposed to each other. In an example in which the electronic apparatus 1000 is completely folded, a display surface FS-F having an area relatively smaller than the area of the display surface FS in the unfolded state may be provided as illustrated in FIG. 1C.

In some embodiments, although not illustrated, the electronic apparatus 1000 may also be folded with respect to a plurality of folding axes spaced apart from each other in the second direction DR2. The electronic apparatus 1000 according to an embodiment of the inventive concept may have various embodiments as long as capable of displaying the image IM and being folded, and is not limited to any one embodiment.

Referring to FIGS. 2A and 2B, the electronic apparatus 1001 may have a shape different from that of the electronic apparatus 1000 illustrated in FIGS. 1A to 1C. Specifically, the electronic apparatus 1001 may have a rectangular shape which has long sides extending in the first direction DR1 and short sides extending in the second direction DR2. However, the electronic apparatus 1001 is not limited thereto, and may have various shapes such as, for example, a circular shape or a polygonal shape. The display surface FS may include a second active region F-AA (an active region) and a second peripheral region F-NAA (a peripheral region). The peripheral region F-NAA is adjacent to the active region F-AA. The peripheral region F-NAA may have a light transmittance lower than the light transmittance of the active region F-AA, and may have a predetermined color.

In this embodiment, a plurality of electronic module regions MHA1 and MHA2 may be defined in the display surface FS, but embodiments of the present disclosure are not limited thereto. The electronic module regions MHA1 and MHA2 are illustrated as being provided in the active region F-AA, but are not limited thereto, and may also be provided in the peripheral region F-NAA. The electronic module regions MHA1 and MHA2 may be regions in which at least one among electronic modules to be described later is disposed. For example, the electronic apparatus 1001 may capture an external object via one region of the electronic module regions MHA1 and MHA2, and may detect an external object via the other region of the electronic module regions MHA1 and MHA2. In this embodiment, the peripheral region F-NAA may surround the active region F-AA, but embodiments of the present disclosure are not limited thereto. Accordingly, a shape of the active region F-AA may be substantially defined by the peripheral region F-NAA. However, this is illustrated as an example, and the peripheral region F-NAA may not only be disposed adjacent to a single side of the active region F-AA but also be omitted.

Unlike the electronic apparatus 1000 illustrated in FIG. 1A, the electronic apparatus 1001 may be folded with respect to a second folding axis AX2 extending along the second direction DR2. The second folding axis AX2 may be disposed below the display surface FS, and the electronic apparatus 1001 may be outwardly-folded with respect to the second folding axis AX2. Accordingly, the first non-folding region NFA1, the folding region FA, and the second non-folding region NFA2 may be arranged along the first direction DR1.

Referring to FIG. 2B, in a folded state of an electronic apparatus 1001_F, a display surface on which an image is displayed may be viewed by a user. Information provided by the electronic apparatus 1001_F may be easily viewed by a user through the electronic apparatus 1001_F even in a folded state. According to an embodiment of the inventive concept, a foldable display is suitable enough for the electronic apparatus 1001. The position of a folding axis AX3 may be diversely changed, and is not limited to any one embodiment.

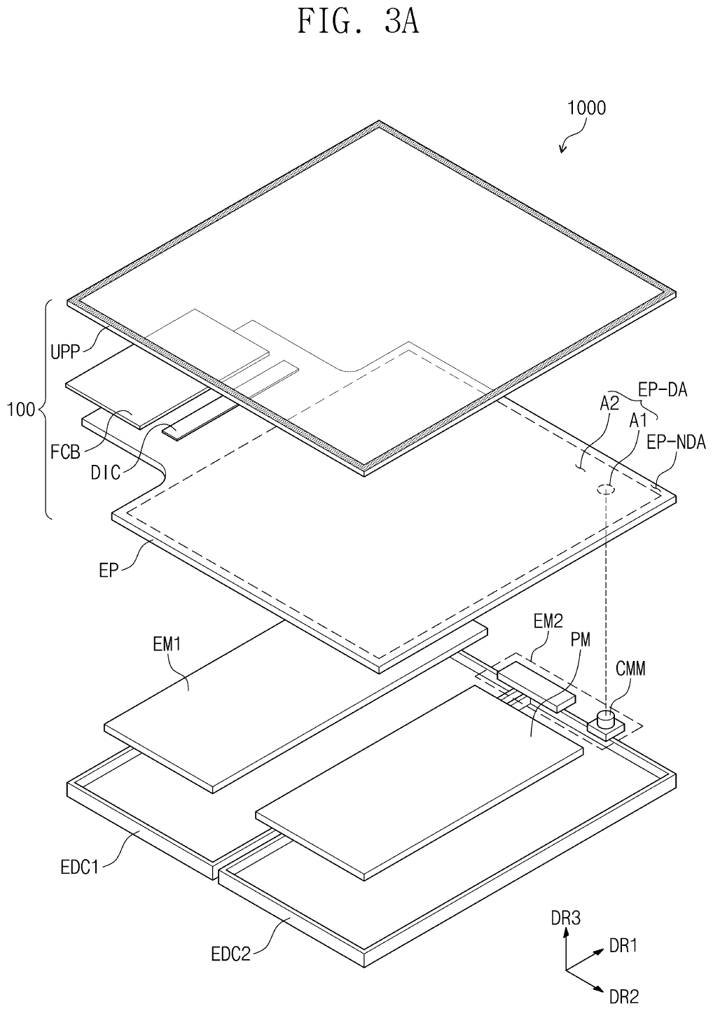

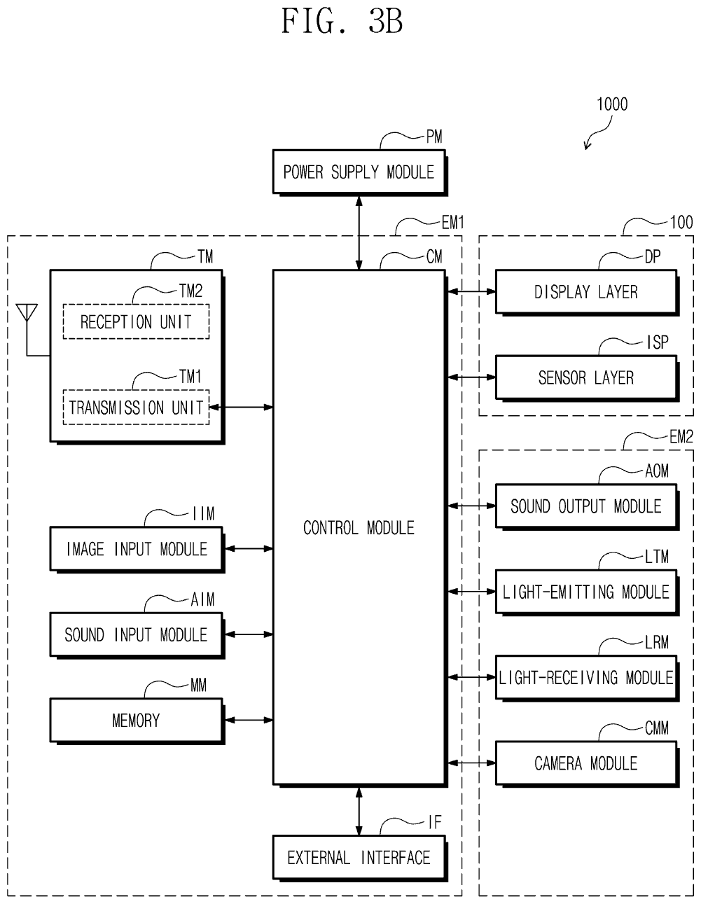

FIG. 3A is an exploded perspective view of a display apparatus according to an embodiment of the inventive concept. FIG. 3B is a block diagram of a display apparatus according to an embodiment of the inventive concept. FIGS. 3A and 3B illustrate example aspects of the electronic apparatus 1000 illustrated in FIG. 1A, but these are presented as non-limiting examples. The content to be described herein may be commonly applied to the electronic apparatus 1001 illustrated in FIG. 2A. Hereinafter, an embodiment of the inventive concept will be described with reference to FIGS. 3A and 3B.

Referring to FIGS. 3A and 3B, an electronic apparatus 1000 may include a display apparatus 100, a first electronic module EM1, a second electronic module EM2, a power supply module PM, and housings EDC1 and EDC2. The electronic apparatus 1000 may further include a mechanical structure for controlling a folding operation of the display apparatus 100.

The display apparatus 100 includes a window member UPP and an electronic panel EP. The window member UPP covers an upper surface of the electronic panel EP and provides a front surface of the electronic apparatus 1000.

FIG. 3A illustrates only the electronic panel EP and the window member UPP as components of the display apparatus 100, but the display apparatus 100 may be substantially a stacked structure in which a plurality of components including the electronic panel EP are stacked. For example, the display apparatus 100 may further include at least one component, such as, for example, a support plate or an impact absorbing layer disposed on a rear surface of the electronic panel EP.

The electronic panel EP includes a display region DP-DA and a non-display region DP-NDA. The display region DP-DA may correspond to the above-described active region F-AA (see FIG. 1A), and the non-display region DP-NDA may correspond to the above-described peripheral region F-NAA (see FIG. 1A). In this specification, the wording “a region/portion corresponds to a region/portion” means overlapping each other, and is not limited to having the same area.

The display region DP-DA may include a first region A1 and a second region A2. The first region A1 may overlap or correspond to the electronic module region MH (see FIG. 1A) of the electronic apparatus 1000. In the embodiment, the first region A1 is illustrated to have a circle shape, but may have various shapes, such as, for example, a polygon shape, an ellipse shape, a figure having at least one curved side, or an irregular shape, and is not limited to any one embodiment. The first region A1 may be referred to as a component region, and the second region A2 may be referred to as a main display region or a general display region.

The first region A1 may have higher light transmittance than the second region A2. In some aspects, the resolution of the first region A1 may be lower than the resolution of the second region A2, but is not limited thereto. For example, the first region A1 has a higher light transmittance than the second region A2, but the resolution of the first region A1 may also be the substantially the same as the resolution of the second region A2. The first region A1 may overlap a camera module CMM. In an embodiment of the inventive concept, a portion of the electronic panel EP corresponding to the first region A1 may be removed. Therefore, an image may also not be displayed on the first region A1.

The electronic panel EP may include a display layer DP and a sensor layer ISP. The display layer DP may be a component for substantially generating an image. The display layer DP may be a light-emitting display layer. For example, the display layer DP may be an organic light-emitting display layer, an inorganic light-emitting display layer, an organic-inorganic light-emitting display layer, a quantum dot display layer, a micro LED display layer, or a nano LED display layer.

The sensor layer ISP may detect an external input applied from the outside. The external input may be a user's input. The user's input may include various types of external inputs such as, for example, a part of a user's body, light, heat, a pen, or pressure.

A driving unit DIC and a circuit board FCB may include driving elements for driving pixels of the display layer DP. For example, the driving unit DIC may include a gate driving circuit or a data driving circuit, and for example, the circuit board FCB may include a timing control circuit or a power supply circuit. Alternatively, the driving unit DIC and the circuit board FCB may include driving elements for driving the sensor layer ISP. However, this is described as an example. The driving elements for driving the sensor layer ISP may also be provided on a separate board from the driving unit DIC or the circuit board FCB, and are not limited to any one embodiment.

The driving unit DIC may be disposed in the non-display region DP-NDA. However, this is illustrated as an example, and the driving unit DIC may also be disposed in the display region DP-DA. An arrangement position of the driving unit DIC is not limited to any one embodiment. FIG. 3A illustrates a structure in which the driving unit DIC in a form of a chip is mounted on the electronic panel EP, but embodiments of the present disclosure are not limited thereto. For example, the driving unit DIC may be mounted on the circuit board FCB, and also be connected to the electronic panel EP via the circuit board FCB.

The power supply module PM supplies power for the overall operation of the electronic apparatus 1000. The power supply module PM may include a typical battery module. Although not illustrated, the circuit board FCB may be connected to the power supply module PM and receive power, and the power for the electronic panel EP or the driving unit DIC may be supplied via the circuit board FCB.

The first electronic module EM1 and the second electronic module EM2 may include various functional modules for operating the electronic apparatus 1000. The first electronic module EM1 and the second electronic module EM2 may each be directly mounted on a motherboard electrically connected to the electronic panel EP, or may be mounted on a separate board to be electrically connected to the motherboard via a connector (not illustrated), etc. The motherboard may not only be separately provided but also correspond to the circuit board FCB.

The first electronic module EM1 may include a control module CM, a wireless communication module TM, an image input module IIM, a sound input module AIM, a memory MM, and an external interface IF.

The control module CM controls overall operation of the electronic apparatus 1000. The control module CM may be a microprocessor. For example, the control module CM activates or deactivates the electronic panel EP. The control module CM may control other modules such as, for example, the image input module IIM or the sound input module AIM on the basis of a touch signal received from the electronic panel EP.

The wireless communication module TM may communicate with an external electronic apparatus via a first network (for example, a short-range communication network such as, for example, Bluetooth, WiFi direct, or infrared data association (IrDA)) or a second network (for example, long-range wireless communication network such as, for example, a cellular network, Internet, or a computer network (for example: LAN or WAN)). Communication modules included in the wireless communication module TM may be integrated into one component (for example, a single chip) or be implemented as a plurality of components (for example, multiple chips) separated from each other. The wireless communication module TM may transmit/receive voice signals via general communication lines. The wireless communication module TM may include a transmission unit TM1 which modulates a signal to be transmitted and transmits the signal, and a reception unit TM2 which demodulates a received signal.

The image input module IIM processes an image signal and converts the image signal into image data capable of being displayed through the electronic panel EP. The sound input module AIM receives an external sound signal through a microphone in a recording mode, a voice recognition mode, etc., and converts the received sound signal into electrical voice data.

The external interface IF may include a connector capable of physically connecting the electronic apparatus 1000 to an external electronic apparatus. For example, the external interface IF serves as an interface connected to an external charger, wired/wireless data ports, a card (for example, a memory card, a SIM/UIM card) socket, etc.

The second module EM2 may include a sound output module AOM, a light-emitting module LTM, a light-receiving module LRM, the camera module CMM, etc. The sound output module AOM converts sound data received from the wireless communication module TM or sound data stored in the memory MM and then outputs the converted sound data to the outside.

The light-emitting module LTM generates and outputs light. The light-emitting module LTM may output infrared light. The light-emitting module LTM may include an LED element. The light-receiving module LRM may detect infrared light. The light-receiving module LRM may be activated when the infrared light in a certain level or higher is detected. The light-receiving module LRM may include a CMOS sensor. The infrared light generated in the light-emitting module LTM is output, and then is reflected onto an external object (for example, a finger or face of a user). The reflected infrared light may be incident on the light receiving module LRM.

The camera module CMM may capture still images and moving images. The camera modules CMM may be provided in plurality. Some of the camera modules CMM may overlap the first region A1. The external input (for example, light) may be provided to the camera module CMM via the first region A1. For example, the camera module CMM may capture an external image by receiving natural light via the first region A1.

The housings EDC1 and EDC2 accommodate the electronic panel EP, the first and second electronic modules EM1 and EM2, and the power supply module PM. The housings EDC1 and EDC2 protect components such as, for example, the electronic panel EP, the first and second electronic modules EM1 and EM2, and the power supply module PM, which are accommodated in the housings EDC1 and EDC2. FIG. 3A illustrates an example of two housings EDC1 and EDC2 separated from each other, but embodiments of the present disclosure are not limited thereto. Although not illustrated, the electronic apparatus 1000 may further include a hinge structure for connecting the two housings EDC1 and EDC2 to each other. The housings EDC1 and EDC2 may be coupled to a window member UPP. The electronic apparatus 1000 according to an embodiment of the inventive concept may include various components in addition to the above-described components, and may also be provided while any components illustrated or described with reference to the electronic apparatus 1000 are omitted, but is not limited to any one embodiment.

FIGS. 4A and 4B are cross-sectional views briefly illustrating an electronic apparatus according to an embodiment of the inventive concept. FIG. 4A is a cross-sectional view illustrating an electronic apparatus 1000, illustrated in FIG. 1A, in an unfolded state, and FIG. 2B illustrates an electronic apparatus 1000-F in a folded state. Hereinafter, an embodiment of the inventive concept will be described with reference to FIGS. 4A and 4B.

The electronic apparatuses 1000 and 1000-F may include a window member UPP, an electronic panel EP, and a lower member LPP. The lower member LPP may be bonded to a rear surface of the electronic panel EP via an adhesive layer ASL.

The electronic panel EP has flexibility. Accordingly, the electronic panel EP may be folded or unfolded with respect to a folding axis FX. The electronic panel EP may include a display panel on which an image is displayed, a sensing panel which detects an external input, or a combination thereof. In this embodiment, the electronic panel EP includes a display panel, but embodiments of the present disclosure are not limited thereto. Accordingly, the electronic panel EP displays the image IM (see FIG. 1A). The display panel may be one of a liquid crystal display panel, an organic light-emitting display panel, an electro-phoretic display panel, or an electro-wetting display panel. The electronic panel EP may include a plurality of pixels. The pixels may each generate light for implementing the image IM.

The lower member LPP is disposed on a rear surface of the electronic panel EP. The lower member LPP may have a modulus or elasticity higher than those of the electronic panel EP. The lower member LPP prevents external impacts, applied from below the electronic apparatus 1000, from being transmitted to the electronic panel EP, thereby making it possible to improve reliability of the electronic apparatus 1000.

The adhesive layer ASL is disposed between the electronic panel EP and the lower member LPP, and bonds the electronic panel EP and the lower member LPP. In some embodiments, the adhesive layer ASL may also be omitted. In this case, the lower member LPP may be directly formed on the rear surface of the electronic panel EP to be in close contact with the electronic panel EP, and is not limited to any one embodiment.

The window member UPP is disposed on the electronic panel EP. An upper surface of the window member UPP defines the front surface FS (see FIG. 1A) of the electronic apparatus 1000. The window member UPP is disposed on a display surface of the electronic panel EP. The window member UPP may be optically transparent. Accordingly, the image IM generated from the electronic panel EP may pass through the window member UPP to be easily viewed by a user.

The window member UPP has flexibility. Accordingly, the window member UPP may be folded or unfolded with respect to the folding axis FX. In some aspects, since the electronic apparatus 1000 according to an embodiment may be outwardly-folded with respect to the folding axis FX, the window member UPP forms an outer surface of the electronic apparatus 1000 even in a folded state of the electronic apparatus 1000.

Referring to FIG. 4B, the folded electronic apparatus 1000-F may be folded in a manner that the lower member LPP surrounds the folding axis FX. The folding axis FX is defined on a rear surface of the electronic apparatus 1000, that is, a surface opposed to the display surface, and components which constitute the electronic apparatus 1000 each are folded with respect to the folding axis FX.

The lower member LPP most adjacent to the folding axis FX may be folded within a first curvature radius R1 with respect to the folding axis FX. The first curvature radius R1 may be defined as a distance from a rear surface (or an outer surface) of the lower member LPP to the folding axis FX.

The window member UPP most spaced apart from the folding axis FX may be folded within a second curvature radius R2. The second curvature radius R2 may be defined as a distance from an upper surface of the lower member UPP to the folding axis FX. The first curvature radius R1 and the second curvature radius R2 may be about 2 mm or less. The electronic apparatus 1000 according to the inventive concept may be stably folded within a fine curvature radius.

In this embodiment, the folding axis FX is defined on the rear surface of the electronic apparatus 1000, but embodiments of the present disclosure are not limited thereto. Accordingly, the second curvature radius R2 has a greater value than the first curvature radius R1. Therefore, the window member UPP may be folded to have a curvature radius greater than that of the lower member LPP or the electronic panel EP. In some aspects, the window member UPP in a folded state may define an outer surface of the electronic apparatus 1000-F. That is, the window member UPP according to the inventive concept constitutes an outer surface of each of the electronic apparatuses 1000 and 1000-F in a state in which the electronic apparatus 1000-F is folded or the electronic apparatus 1000 is unfolded. Accordingly, embodiments of the present disclosure support implementations in which the window member UPP, among components which constitute the electronic apparatus 1000 has excellent flexural properties and impact resistance. According to the inventive concept, the window member UPP, which includes at least one among hard films HFL1 and HFL2 and a soft film SFL having controlled thicknesses and moduli, is provided. Therefore, embodiments of the present disclosure may provide the window member UPP with the flexural properties and impact resistance further improved than those of a window member of a foldable electronic apparatus.

Specifically, the window member UPP may include a first hard film HFL1, a second hard film HFL2, the soft film SFL, and a plurality of adhesive layers AS1, AS2, and AS3. The adhesive layers AS1, AS2, AS3, and ASL according to this embodiment may each include a pressure sensitive adhesive layer PSA.

The window member UPP according to an embodiment of the inventive concept may have a thickness ranging from about 300 μm to about 600 μm. A thickness of the window member UPP may be a total thickness including thicknesses of the first and second hard films HFL1 and HFL2, and the soft film SFL as well as thicknesses of the adhesive layers AS1, AS2, and AS3. That is, the thickness of the window member UPP may correspond to a distance from an upper surface of the electronic panel EP, to which the window member UPP is attached, to an upper surface of the first hard film HFL1 which is the uppermost layer of the window member UPP.

When the window member UPP has a thickness of less than about 300 μm, folding properties may be improved, but both pen drop performance and ball drop performance may be deteriorated. That is, in some approaches, it may be difficult to provide a window with the minimum impact resistance desired (i.e., a target minimum impact resistance) for protection of the electronic panel EP. In an example in which the window member UPP has a thickness of greater than about 600 μm, a defect caused by de-lamination, such as, for example, buckling, may occur in a case in which a folding evaluation is performed at a low temperature of about −20° C. That is, when the thickness of the window member UPP increases, low-temperature flexural properties may deteriorate. Accordingly, the window member UPP according to the inventive concept may have a thickness ranging from about 300 μm to about 600 μm, thereby making it possible to ensure flexural properties and impact resistance suitable for an out-folding operation.

The first hard film HFL1 may be disposed on the uppermost part of the window member UPP, and define an upper surface of the window member UPP. The first hard film HFL1 may be farthest spaced apart from the electronic panel EP among the films which constitute the window member UPP. The first hard film HFL1 may protect a top surface of the electronic apparatus 1000. The first hard film HFL1 may have a predetermined hardness. That is, the first hard film HFL1 may have a modulus (a tensile modulus) of greater than about 2 Gpa at a high temperature of about 25° C. The first hard film HFL1 may have a thickness T1 ranging from about 75 μm to about 150 μm. As the thickness T1 of the first hard film HFL1 becomes small, flexural properties may be improved, but strength may be deteriorated. In an example in which the first hard film HFL1 has a thickness T1 of less than about 75 μm, it may be difficult to secure sufficient impact resistance due to low pen drop performance. In some aspects, when the first hard film HFL1 has a thickness T1 of greater than about 150 μm, defects caused by de-lamination phenomenon, etc., such as, for example, buckling, may occur in a case in which a folding evaluation is performed at a low temperature of about −20° C. Accordingly, the first hard film HFL1 according to the inventive concept has a thickness within an appropriate range, thereby making it possible to secure the flexural properties and the impact resistance suitable for an out-folding operation.

The soft film SFL may be disposed between the first hard film HFL1 and the electronic panel EP. The soft film SFL may have a predetermined flexibility, and a lower modulus than the first hard film HFL1. For example, the soft film SFL may have a modulus of about 1 Gpa or less.

As the film has a low modulus, ball drop performance, which is a type of impact resistance for a film, may be high, but pen drop performance may be low. The soft film SFL may have a modulus ranging from about 0.01 Gpa to about 1 Gpa at a high temperature of about 25° C. In an example in which the soft film SFL has a modulus of less than about 0.01 Gpa, it may be difficult to stably protect the electronic panel EP of the electronic apparatus during an out-folding operation since pen drop performance is low. In an example in which the soft film SFL has a modulus of greater than about 1 Gpa, it may be difficult to stably protect the electronic panel EP of the electronic apparatus during an out-folding operation due to low ball drop performance.

In some aspects, the soft film SFL may have a modulus ranging from about 0.5 Gpa to about 2 Gpa at a low temperature of about −20° C. In an example in which the soft film SFL has a modulus of less than about 0.5 Gpa, it may be difficult to stably protect the electronic panel EP of the electronic apparatus during an out-folding operation due to low ball drop performance. In an example in which the soft film SFL has a modulus of greater than about 2 Gpa, it may be difficult to stably protect the electronic panel EP of the electronic apparatus during an out-folding operation due to low ball drop performance.

The soft film SFL may have a thickness TS of about 50 μm to about 150 μm. In an example in which the soft film SFL has a thickness of about less than about 50 μm, folding properties may be improved, but both pen drop performance and ball drop performance may be deteriorated. That is, in some approaches, it may be difficult to provide a window with the minimum impact resistance desired or targeted for protection of the electronic panel EP. In an example in which the soft film SFL has a thickness TS of greater than about 150 μm, impact resistance may be sufficiently secured, but the thickness is excessively increased, which may cause process costs to rise.

The soft film SFL may have a recovery rate of about 90% or more. Recovery rate a certain element refers to a degree which a deformed part returns to its initial form when an external force is removed after the deformed part has been subjected to an external force. Typically, it may be measured as the ratio of the depth restored when the external force is removed to the depth deformed when pressing with the external force of 100 mN using a ball-tip indenter. In an example in which the soft film SFL has a recovery rate of less than about 90%, it may be difficult to improve the ball drop performance. The soft film SFL has a recovery rate of about 90% or more, thereby making it possible to secure sufficient impact resistance suitable for an out-folding structure.

The soft film SFL may be optically transparent. That is, the soft film SFL may have light transmittance of about 90% or more. In some aspects, the soft film SFL may have a haze of about 2% or less. Since the soft film SFL has light transmittance and a haze such that the soft film SFL is optically transparent, an image which is displayed on the electronic panel EP may be easily viewed by a user via the window member UPP. The soft film SFL may prevent deterioration in light transmittance of the window member UPP or display properties of the electronic apparatus 1000.

The second hard film HFL2 may be disposed between the first hard film HFL1 and the electronic panel EP. The second hard film HFL2 may have a predetermined hardness. The second hard film HFL2 may have a modulus which is higher than that of the soft film SFL and is at least greater than about 2 Gpa at a high temperature of about 25° C. In this embodiment, the second hard film HFL2 may have a thickness T2 ranging from about 25 μm to about 150 μm, but embodiments of the present disclosure are not limited thereto.

According to the inventive concept, embodiments of the present disclosure support implementations in which the window member UPP, among components which constitute the electronic apparatus 1000 having an out-folding structure, has flexural properties and impact resistance higher than those of an electronic apparatus having an in-folding structure. According to the inventive concept, the window member UPP, which includes at least one among the hard films HFL1 and HFL2 and the soft film SFL having controlled thicknesses and moduli, is provided. Therefore, embodiments of the present disclosure may provide the window member UPP with the flexural properties and impact resistance further improved than those of a window member of a foldable electronic apparatus.

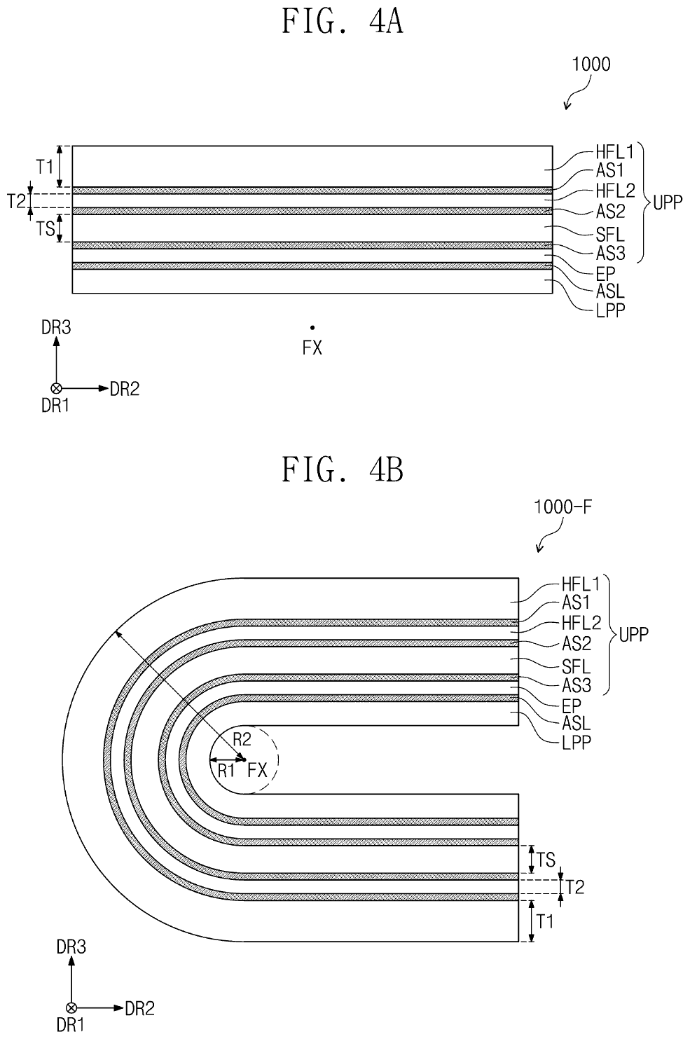

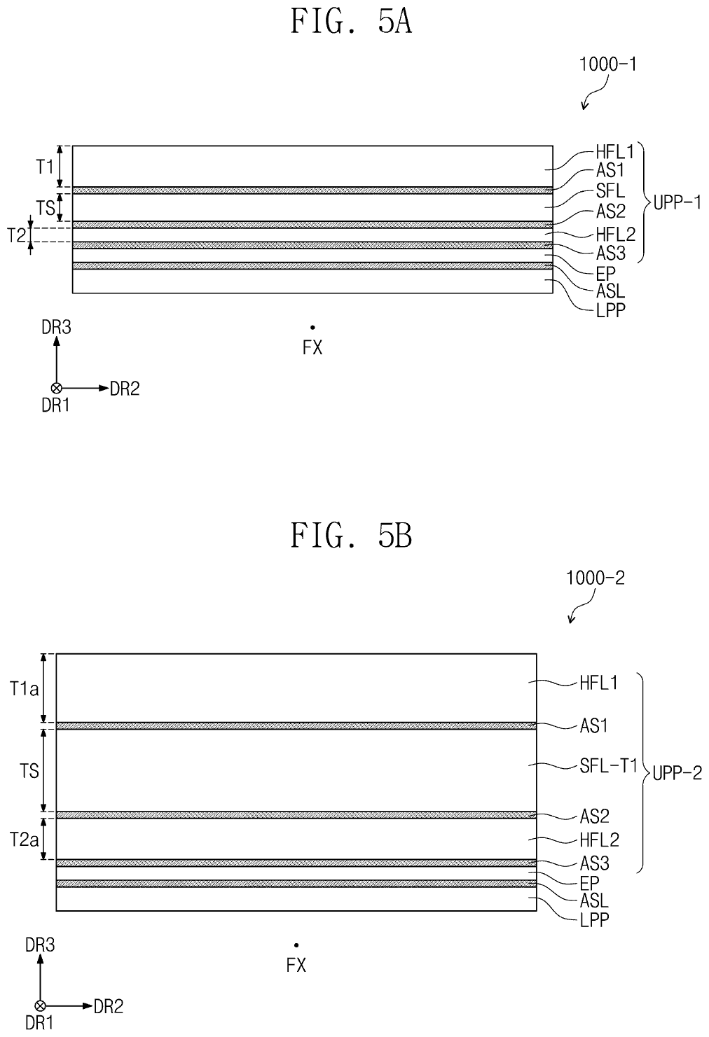

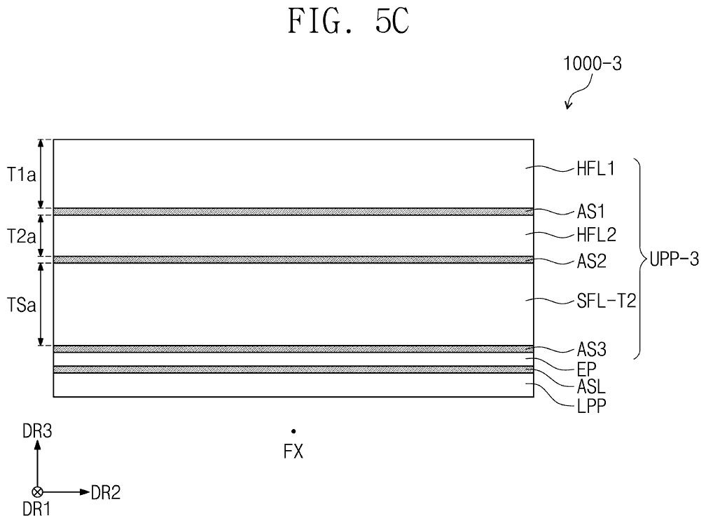

FIGS. 5A to 5C are cross-sectional views of an electronic apparatus according to embodiments of the inventive concept. In FIGS. 5A to 5C, views corresponding to that illustrated in FIG. 4A are illustrated for ease of description. Hereinafter, an embodiment of the inventive concept will be described with reference to FIGS. 5A to 5C. The same reference numerals or symbols are given to the components same as those described with reference to FIGS. 1A to 4B, and the duplicated descriptions will be omitted.

As illustrated in FIG. 5A, in an electronic apparatus 1000-1, a window member UPP-1 may include a first hard film HFL1, a second hard film HFL2, a soft film SFL, and a plurality of adhesive layers AS1, AS2, and AS3. Unlike the window member UPP illustrated in FIG. 4A, the soft film SFL illustrated in FIG. 5A may be disposed between the first hard film HFL1 and the second hard film HFL2. In this case, the second hard film HFL2 may be bonded to the electronic panel EP, with the adhesive layer AS3 between the second hard film HFL2 and the electronic panel EP.

The window member UPP-1 may have a thickness ranging from about 300 μm to about 600 μm. The first hard film HFL1 may have a thickness ranging from about 75 μm to about 150 μm. The second hard film HFL2 may have a thickness ranging from about 25 μm to about 150 μm. The soft film SFL may have a thickness ranging from about 50 μm to about 150 μm.

The electronic apparatus 1000-2 illustrated in FIG. 5B may be illustrated as an embodiment in which the thickness is specified in order to conduct an experiment on the stacked structure same as that of the window member UPP-1 illustrated in FIG. 5A (see FIG. 5A). A window member UPP-2 may include a first hard film HFL1, a second hard film HFL2, a soft film SFL-T1, and a plurality of adhesive layers AS1, AS2, and AS3. The first hard film HFL1 may have a modulus of about 4 Gpa at a high temperature and a thickness T1a of about 125 μm. The second hard film HFL2 may have a modulus same as that of the first hard film HFL1 and a thickness T2a of about 75 μm. The soft film SFL-T1 may have a modulus of about 0.9 Gpa at a high temperature, a modulus of about 1.3 Gpa at a low temperature, a recovery rate of about 94.8%, and a thickness TS of about 150 μm. In an example in which the window member UPP-2 has a thickness of about 555 μm, upon examining impact resistance of the window member UPP-2, it was measured that the pen drop performance was about 28 cm and the ball drop performance was about 44 cm. The recovery rate was measured by a ball-tip indenter of about 100 mN. It may be seen that generally, the window member having an in-folding structure has a pen drop performance of about 10 cm and a ball drop performance of about 9 cm whereas the window member UPP-2 has relatively high impact resistance.

Table 1 below illustrates the pen drop performances and ball drop performances obtained by varying the modulus or the thickness TS of the soft film SFL-T1.

TABLE 1

| | E1 | E2 | E3 | E4 | E5 |
|---|---|---|---|---|---|
| Thickness of Window | 555 μm | 555 μm | 555 μm | 555 μm | 505 μm |
| member | | | | | |
| Thickness of Soft film | 150 μm | 150 μm | 150 μm | 150 μm | 100 μm |
| Modulus of Soft film at | 0.2 GPa/ | 0.08 GPa/ | 0.4 GPa/ | 0.9 GPa/ | 0.9 GPa/ |
| High temperature/Low | 0.5 GPa | 0.8 GPa | 1.3 GPa | 1.2 GPa | 1.2 GPa |
| temperature | | | | | |
| Pen drop | 24 | 27 | 27 | 28 | 25 |
| Ball drop | 60 | 49 | 49 | 44 | 39 |

Referring to Table 1, first to fourth examples E1, E2, E3, and E4 may be designed by varying the modulus of the soft film SFL-T1 included in the window member UPP-2. A fifth example E5 may be designed by varying the thickness of the soft film SFL-T1, compared to the fourth example E4. All the first to fifth examples E1, E2, E3, E4, and E5 may satisfy the thickness range of the window member UPP-2, and the thickness range and the modulus range of the soft film SFL-T1. That is, in each of the first to fifth examples E1, E2, E3, E4, and E5, the soft film SFL-T1 may have a modulus ranging from about 0.01 Gpa to about 1 Gpa at a high temperature of about 25° C., and a modulus ranging from about 0.5 Gpa to about 2 Gpa at a low temperature of about −20° C. In each of the first to fifth examples E1, E2, E3, E4, and E5, the soft film SFL-T1 may have a thickness TS ranging from about 50 μm to about 150 μm. Referring to Table 1, it may be seen that all the pen drop performances in the first to fifth examples E1, E2, E3, E4, and E5 are about 20 cm or more, the ball drop performance in the first example E1 illustrates a relatively high value of about 60 cm, and the ball drop performance in the fifth example E5 illustrates a relatively low value of about 39 cm, but all the ball drop performances show high values, having a difference of about 20 cm or more from about 9 cm. Since the thickness range of the window member UPP-2 according to the inventive concept, and the thickness range and the modulus range of each of the films are specified, embodiments supported by the present disclosure may secure sufficient folding properties and impact resistance, and thus the electronic apparatus 1000-2 having an out-folding structure may be easily implemented.

The electronic apparatus 1000-3 illustrated in FIG. 5C may be illustrated as an embodiment in which the thickness is specified in order to conduct an experiment on the stacked structure same as that of the window member UPP (see FIG. 4A). A window member UPP-3 may include a first hard film HFL1, a second hard film HFL2, a soft film SFL-T2, and a plurality of adhesive layers AS1, AS2, and AS3. The first hard film HFL1 may have a modulus of about 4 Gpa at a high temperature and a thickness T1a of about 125 μm. The second hard film HFL2 may have a modulus same as that of the first hard film HFL1, and a thickness T2a of about 75 μm. The soft film SFL-T2 may have a modulus of about 0.9 Gpa at a high temperature, a modulus of about 1.3 Gpa of at a low temperature, a recovery rate of about 94.8%, and a thickness TSa of about 150 μm. In an example in which the window member UPP-3 has a thickness of about 555 μm, the window member UPP-3 may substantially correspond to the window member UPP-2 illustrated in FIG. 5B having a structure a stacking order of which is changed.

Upon examining impact resistance of the window member UPP-3, it was measured that the pen drop performance was about 36 cm and the ball drop performance was about 21 cm. The recovery rate was measured by a ball-tip indenter of about 100 mN in the same manner as in FIG. 5B. It may be seen that compared to the window member UPP-2 illustrated in FIG. 5B, a position of the soft film SFL is getting closer to the electronic panel EP, and thus the pen drop performances increase and the ball drop performances decrease. It may be seen that generally, the window member having an in-folding structure has a pen drop performance of about 10 cm and a ball drop performance of about 9 cm whereas the window member UPP-3 exhibits relatively high impact resistance.

Table 2 below illustrates the pen drop performances and ball drop performances obtained by varying the modulus or the thickness TSa of the soft film SFL-T2.

TABLE 2

| | E6 | E7 | E8 | E9 | E10 |
|---|---|---|---|---|---|
| Thickness of | 555 μm | 555 μm | 555 μm | 505 μm | 505 μm |
| Window | | | | | |
| member | | | | | |
| Thickness of | 150 μm | 150 μm | 150 μm | 100 μm | 100 μm |
| Soft film | | | | | |
| Modulus of Soft | 0.2 GPa/ | 0.4 GPa/ | 0.9 GPa/ | 0.2 GPa/ | 0.012 GPa/ |
| film at High | 0.5 GPa | 1.3 GPa | 1.2 GPa | 1.0 GPa | 0.7 GPa |
| temperature/Low | | | | | |
| temperature | | | | | |
| Pen drop | 31 | 37 | 36 | 31 | 21 |
| Ball drop | 29 | 23 | 21 | 22 | 24 |

Referring to Table 2, sixth to eighth examples E6, E7, and E8 may be designed by varying the modulus of the soft film SFL-T2 included in the window member UPP-3. A ninth example E9 and a tenth example E10 may be designed by varying the modulus of the soft film SFL-T1 having a different thickness. All the sixth to tenth examples E6, E7, E8, E9, and E10 may satisfy the thickness range of the window member UPP-3, and the thickness range and the modulus range of the soft film SFL-T2. That is, in each of the sixth to tenth examples E6, E7, E8, E9, and E10, the soft film SFL-T2 may have a modulus ranging from about 0.01 Gpa to about 1 Gpa at a high temperature of about 25° C., and a modulus ranging from about 0.5 Gpa to about 2 Gpa at a low temperature of about −20° C. In each of the sixth to tenth examples E6, E7, E8, E9, and E10, the soft film SFL-T2 may have a thickness Tsa of about 50 μm to about 150 μm. Referring to Table 2, it may be seen that in the sixth to tenth examples E6, E7, E8, E9, and E10, the pen drop performances in the seventh example E7 and the eighth example E8, which exhibit high moduli, are respectively about 37 cm and about 36 cm, and the pen drop performance in the tenth example E10, which exhibits the lowest modulus, is about 21 cm, but all the pen drop performances are about 20 cm or more.

In some aspects, it may be seen that the sixth to tenth examples E6, E7, E8, E9, and E10 exhibit the relatively lower ball drop performances than the first to fifth examples E1, E2, E3, E4, and E5, but all the ball drop performances show high values, having a difference of about 10 cm or more from about 9 cm. Since the thickness range of the window member UPP-3 according to the inventive concept, and the thickness range and the modulus range of each of the films are specified, embodiments supported by the present disclosure may secure sufficient folding properties and impact resistance, and thus the electronic apparatus 1000-3 having an out-folding structure may be easily implemented.

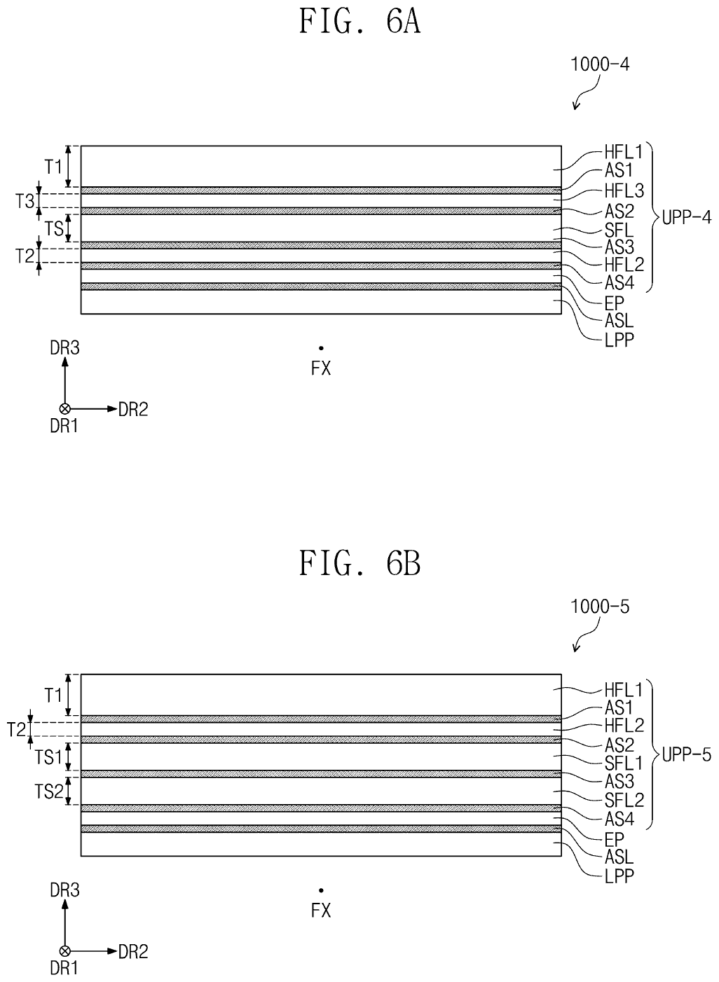

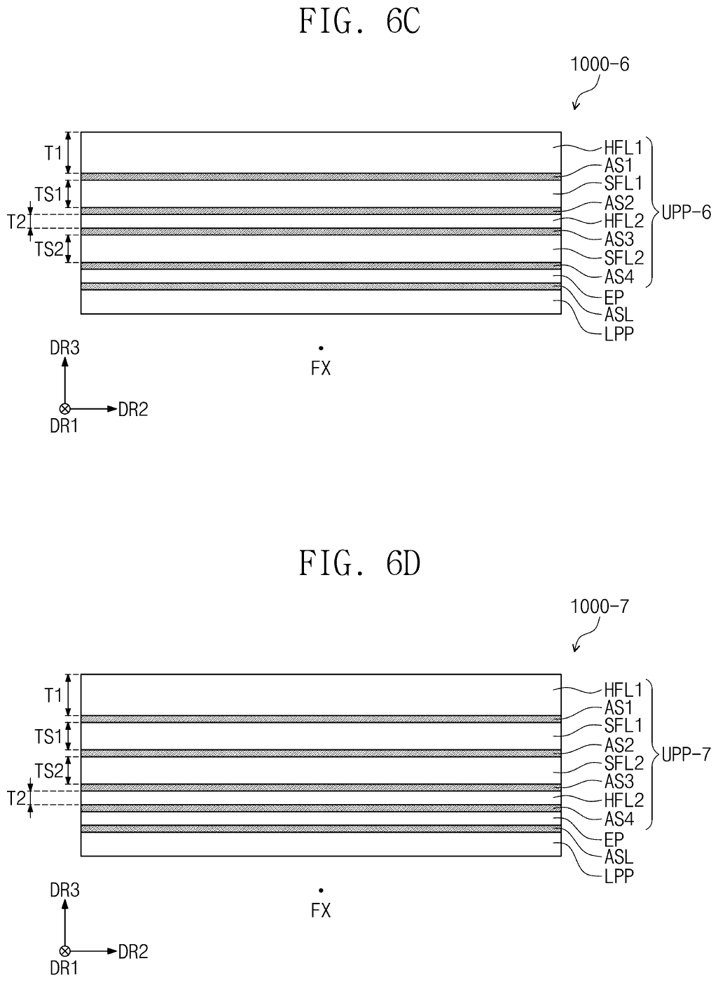

FIGS. 6A to 6D are cross-sectional views of an electronic apparatus according to embodiments of the inventive concept. In FIGS. 6A to 6D, views corresponding to that illustrated in FIG. 4A are illustrated for ease of description. Hereinafter, an embodiment of the inventive concept will be described with reference to FIGS. 6A to 6D. The same reference numerals or symbols are given to the components same as those described with reference to FIGS. 1A to 5C, and the duplicated descriptions will be omitted.

As illustrated in FIG. 6A, in an electronic apparatus 1000-4, a window member UPP-4 may further include a third hard film HFL3. A soft film SFL may be disposed between a first hard film HFL1 and a second hard film HFL2, and the third hard film HFL3 may be disposed between the first hard film HFL1 and the soft film SFL.

The window member UPP-4 may have a thickness ranging from about 300 μm to about 600 μm. The first hard film HFL1 may have a thickness ranging from about 75 μm to about 150 μm. The second hard film HFL2 may have a thickness ranging from about 25 μm to about 150 μm. The soft film SFL may have a thickness ranging from about 50 μm to about 150 μm. The third hard film HFL3 may have a thickness ranging from about 25 μm to about 150 μm. Since the thickness range of the window member UPP-4 according to the inventive concept, and the thickness range and the modulus range of each of the films are specified, embodiments supported by the present disclosure may secure sufficient folding properties and impact resistance, and thus the electronic apparatus 1000-4 having an out-folding structure may be easily implemented.

As illustrated in FIG. 6B, in an electronic apparatus 1000-5, a window member UPP-5 may further include a plurality of soft films SFL1 and SFL2. That is, the window member UPP-5 may include a first hard film HFL1, a second hard film HFL2, a first soft film SFL1, a second soft film SFL2, and a plurality of adhesive layers AS1, AS2, AS3, and AS4. In this embodiment, the first hard film HFL1 and the second hard film HFL2 may be bonded to each other via the adhesive layer AS1, and the first soft film SFL1 and the second soft film SFL2 may be bonded to each other via the adhesive layer AS3, but embodiments of the present disclosure are not limited thereto. The first soft film SFL1 and the second soft film SFL2 may be disposed relatively closer to the electronic panel EP, and the first hard film HFL1 and the second hard film HFL2 may be disposed further outwardly.

The window member UPP-5 may have a thickness ranging from about 300 μm to about 600 μm. The first hard film HFL1 may have a thickness T1 ranging from about 75 μm to about 150 μm. The second hard film HFL2 may have a thickness T2 ranging from about 25 μm to about 150 μm. The first soft film SFL1 may have a thickness TS1 ranging from about 50 μm to about 150 μm. The second soft film SFL2 may have a thickness TS2 ranging from about 50 μm to about 150 μm. Since the thickness range of the window member UPP-5 according to the inventive concept, and the thickness range and the modulus range of each of the films are specified, embodiments supported by the present disclosure may secure sufficient folding properties and impact resistance, and thus the electronic apparatus 1000-5 having an out-folding structure may be easily implemented.

As illustrated in FIG. 6C, compared to the electronic apparatus 1000-5 illustrated in FIG. 6B, an electronic apparatus 1000-6 may also include a window member UPP-6 having a structure in which hard films HFL1 and HFL2, and soft films SFL1 and SFL2 are alternately stacked. That is, in the window member UPP-6, a second soft film SFL2, a second hard film HFL2, a first soft film SFL1, and a first hard film HFL1 may be sequentially stacked along the third direction DR3, with adhesive layers respectively between the second soft film SFL2, the second hard film HFL2, the first soft film SFL1, and the first hard film HFL1.

The window member UPP-6 may have a thickness ranging from about 300 μm to about 600 μm. The first hard film HFL1 may have a thickness T1 ranging from about 75 μm to about 150 μm. The second hard film HFL2 may have a thickness T2 ranging from about 25 μm to about 150 μm. The first soft film SFL1 may have a thickness TS1 ranging from about 50 μm to about 150 μm. The second soft film SFL2 may have a thickness TS2 ranging from about 50 μm to about 150 μm. Since the thickness range of the window member UPP-6 according to the inventive concept, and the thickness range and the modulus range of each of the films are specified, embodiments supported by the present disclosure may secure sufficient folding properties and impact resistance, and thus the electronic apparatus 1000-6 having an out-folding structure may be easily implemented.

As illustrated in FIG. 6D, compared to the electronic apparatus 1000-5 illustrated in FIG. 6B, an electronic apparatus 1000-7 may also include a window member UPP-7 including the hard films HFL1 and HFL2 and the soft films SFL1 and SFL2 which are stacked in different order from that of the electronic apparatus 1000-5. In the window member UPP-7, the soft films SFL1 and SFL2 may be disposed further inward than the hard films HFL1 and HFL2. That is, first and second soft films SFL1 and SFL2 may be disposed between first and second hard films HFL1 and HFL2. The first hard film HFL1 may define the uppermost surface of the window member UPP-7, and the second hard film HFL2 may be bonded to the electronic panel EP via an adhesive layer AS4.

The window member UPP-7 may have a thickness ranging from about 300 μm to about 600 μm. The first hard film HFL1 may have a thickness T1 ranging from about 75 μm to about 150 μm. The second hard film HFL2 may have a thickness T2 ranging from about 25 μm to about 150 μm. The first soft film SFL1 may have a thickness TS1 ranging from about 50 μm to about 150 μm. The second soft film SFL2 may have a thickness TS2 ranging from about 50 μm to about 150 μm. Since the thickness range of the window member UPP-7 according to the inventive concept, and the thickness range and the modulus range of each of the films are specified, embodiments supported by the present disclosure may secure sufficient folding properties and impact resistance, and thus the electronic apparatus 1000-7 having an out-folding structure may be easily implemented.

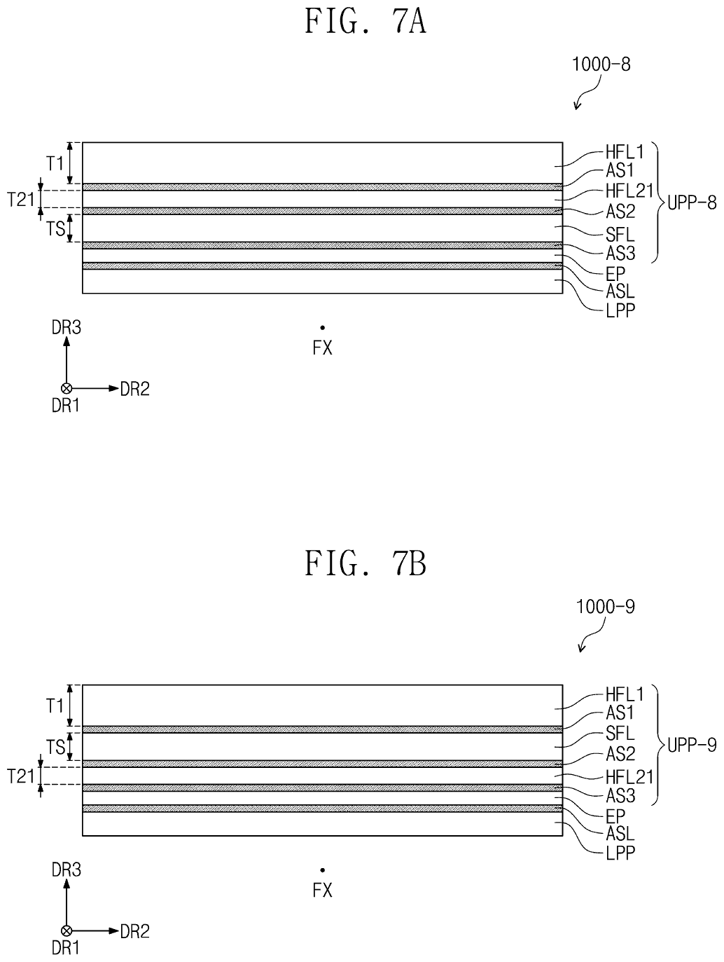

FIGS. 7A and 7B are cross-sectional views of an electronic apparatus according to embodiments of the inventive concept. In FIGS. 7A and 7B, views corresponding to that illustrated in FIG. 4A are illustrated for ease of description. Hereinafter, an embodiment of the inventive concept will be described with reference to FIGS. 7A and 7B. The same reference numerals or symbols are given to the components same as those described with reference to FIGS. 1A to 6D, and the duplicated descriptions will be omitted.

Referring to FIG. 7A, in an electronic apparatus 1000-8, a window member UPP-8 may include a first hard film HFL1, a second hard film HFL21, and a soft film SFL. In this case, the second hard film HFL21 may include a thin-glass. The second hard film HFL21 may be disposed between the first hard film HFL1 and the soft film SFL.

The window member UPP-8 may have a thickness ranging from about 300 μm to about 600 μm. The first hard film HFL1 may have a thickness T1 ranging from about 75 μm to about 150 μm. The first hard film HFL1 may be a resin film. For example, the first hard film HFL1 may be a polyethylene terephthalate film.

The second hard film HFL21 may have a thickness T21 ranging from about 30 μm to about 150 μm. The second hard film HFL21 may be a thin-glass film, and for example, an ultra thin-glass film UTG. Even when the second hard film HFL21 includes glass, the second hard film HFL21 may satisfy a modulus range of about 2 GPa or more. The soft film SFL may have a thickness TS ranging from about 50 μm to about 150 μm. Since the thickness range of the window member UPP-8 according to the inventive concept, and the thickness range and the modulus range of each of the films are specified, embodiments supported by the present disclosure may secure sufficient folding properties and impact resistance, and thus the electronic apparatus 1000-8 having an out-folding structure may be easily implemented. In some aspects, according to the inventive concept, the second hard film HFL21 is replaced with a thin-glass film, thereby providing the window member UPP-8 with improved impact resistance without an increase in the number of stacked layers or an excessive increase in a thickness.

Referring to FIG. 7B, in an electronic apparatus 1000-9, even when a second hard film HFL21 of a window member UPP-9 is a thin-glass film, a position of the second hard film HFL21 may be variously changed. For example, the second hard film HFL21 may also be attached to the electronic panel EP. The soft film SFL may be disposed between the first hard film HFL1 and the second hard film HFL21.

The window member UPP-8 may have a thickness ranging from about 300 μm to about 600 μm. The first hard film HFL1 may have a thickness T1 ranging from about 75 μm to about 150 μm. The second hard film HFL21 may have a thickness T21 ranging from about 30 μm to about 150 μm. The soft film SFL may have a thickness TS ranging from about 50 μm to about 150 μm. Since the thickness range of the window member UPP-9 according to the inventive concept, and the thickness range and the modulus range of each of the films are specified, embodiments supported by the present disclosure may secure sufficient folding properties and impact resistance, and thus the electronic apparatus 1000-9 having an out-folding structure may be easily implemented. In some aspects, according to the inventive concept, the second hard film HFL21 is replaced with a thin-glass film, thereby providing the window member UPP-9 with improved impact resistance without an increase in the number of stacked layers or an excessive increase in a thickness.

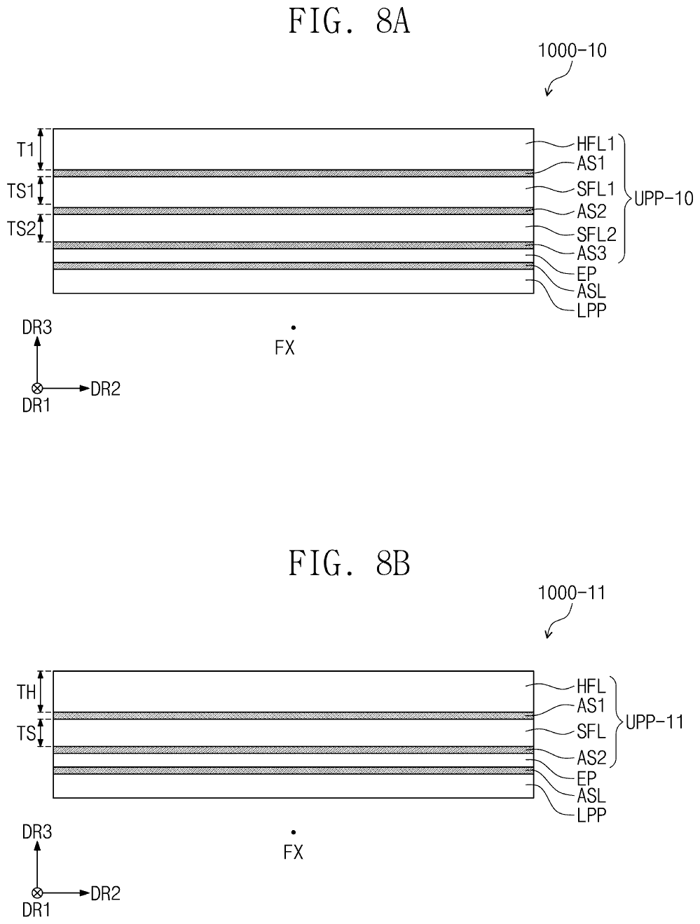

FIGS. 8A and 8B are cross-sectional views of an electronic apparatus according to embodiments of the inventive concept. In FIGS. 8A and 8B, views corresponding to that illustrated in FIG. 4A are illustrated for ease of description. Hereinafter, an embodiment of the inventive concept will be described with reference to FIGS. 8A and 8B. The same reference numerals or symbols are given to the components same as those described with reference to FIGS. 1A to 7B, and the duplicated descriptions will be omitted.

Referring to FIG. 8A, a window member UPP-10 may also be formed of one hard film HFL1 and two soft films SFL1 and SFL2, and adhesive layers AS1, AS2, and AS3. The hard film HFL1 may be disposed in a position most spaced apart from the folding axis FX of an electronic apparatus 1000-10, and the soft films SFL1 and SFL2 may be disposed between the hard film HFL1 and the electronic panel EP.

The window member UPP-10 may have a thickness ranging from about 300 μm to about 600 μm. The hard film HFL1 may have a thickness T1 ranging from about 75 μm to about 150 μm. A first soft film SFL1 may have a thickness TS1 ranging from about 50 μm to about 150 μm. A second soft film SFL2 may have a thickness TS2 ranging from about 50 μm to about 150 μm. Since the thickness range of the window member UPP-10 according to the inventive concept, and the thickness range and the modulus range of each of the films are specified, embodiments supported by the present disclosure may secure sufficient folding properties and impact resistance, and thus the electronic apparatus 1000-10 having an out-folding structure may be easily implemented.

Referring to FIG. 8B, a window member UPP-11 may also be formed of one hard film HFL and one soft film SFL, and adhesive layers AS1 and AS2. The hard film HFL having a relatively high modulus may be disposed at a position most spaced apart from the folding axis FX of an electronic apparatus 1000-11, and the soft film SFL may be disposed between the hard film HFL and the electronic panel EP.

The window member UPP-11 may have a thickness ranging from about 300 μm to about 600 μm. The hard film HFL may have a thickness TH ranging from about 75 μm to about 150 μm. The soft film SFL may have a thickness TS ranging from about 50 μm to about 150 μm. Since the thickness range of the window member UPP-11 according to the inventive concept, and the thickness range and the modulus range of each of the films are specified, embodiments supported by the present disclosure may secure sufficient folding properties and impact resistance, and thus the electronic apparatus 1000-11 having an out-folding structure may be easily implemented.

According to an embodiment of the inventive concept, thicknesses and moduli of a plurality of films, which constitute a window member of an electronic apparatus, are designed in a predetermined range, thereby making it possible to implement a foldable stacked structure which may secure flexibility as well as rigidity. Therefore, the electronic apparatus, in which stress due to a folding operation is relaxed as well as impact resistance is improved, may be provided.

Although the embodiments of the inventive concept have been described, it is understood that the inventive concept should not be limited to the example embodiments but various changes and modifications can be made by one ordinary skilled in the art within the spirit and scope of the inventive concept as hereinafter claimed. Therefore, the technical scope of the inventive concept is not limited to the contents described in the detailed description of the specification, but should be determined by the claims.

What is claimed is:

1. An electronic apparatus comprising:
an electronic panel comprising a light-emitting element and foldable with respect to a folding axis extending along a first direction; and
a window member disposed on the electronic panel and foldable with respect to the folding axis,
wherein:
the window member comprises
a first hard film disposed on an uppermost part of the window member,
a soft film disposed between the first hard film and the electronic panel and having a modulus lower than a modulus of the first hard film, and
a second hard film disposed between the first hard film and the electronic panel and having a modulus higher than a modulus of the soft film, and
the soft film has a recovery rate of about 90% or more.

2. The electronic apparatus of claim 1, wherein a distance between an upper surface of the electronic panel and an upper surface of the first hard film ranges from about 300 μm to about 600 μm.

3. The electronic apparatus of claim 2, wherein a thickness of the soft film is greater than a thickness of the second hard film.

4. The electronic apparatus of claim 3, wherein the second hard film is disposed between the soft film and the electronic panel.

5. The electronic apparatus of claim 3, wherein the second hard film is disposed between the soft film and the first hard film.

6. The electronic apparatus of claim 1, wherein the first hard film has a thickness of about 75 μm.

7. The electronic apparatus of claim 6, wherein the second hard film has a thickness smaller than the thickness of the first hard film.

8. The electronic apparatus of claim 1, further comprising a second soft film disposed between the first hard film and the electronic panel.

9. The electronic apparatus of claim 8, wherein the soft film and the second soft film are bonded with an adhesive layer between the soft film and the second soft film.

10. The electronic apparatus of claim 8, wherein the soft film and the second soft film are disposed between the first hard film and the second hard film.

11. The electronic apparatus of claim 8, wherein the soft film and the second soft film are disposed between the electronic panel and the second hard film.

12. The electronic apparatus of claim 1, further comprising a third hard film disposed between the soft film and the first hard film,
wherein the second hard film is disposed between the soft film and the electronic panel.

13. The electronic apparatus of claim 1, wherein the second hard film comprises a thin-glass film.

14. The electronic apparatus of claim 13, wherein:
the second hard film has a thickness of about 30 μm or more, and
the soft film has a thickness of about 50 μm or more.

15. The electronic apparatus of claim 1, wherein the second hard film is disposed between the soft film and the electronic panel.

16. The electronic apparatus of claim 1, wherein the second hard film is disposed between the soft film and the first hard film.

17. The electronic apparatus of claim 1, wherein the electronic panel further comprises a sensor layer which detects an external input.

18. An electronic apparatus comprising:
an electronic panel comprising a light-emitting element and foldable with respect to a folding axis extending along a first direction;
a lower member disposed between the folding axis and the electronic panel; and
a window member disposed on an upper surface of the electronic panel and foldable with respect to the folding axis,
wherein:
the window member comprises
a first hard film disposed on an uppermost part of the window member,
a soft film disposed between the first hard film and the electronic panel and having a modulus lower than a modulus of the first hard film,
a second hard film disposed between the first hard film and the soft film and having a modulus higher than a modulus of the soft film, and
a plurality of adhesive layers, and
the window member has a thickness ranging from about 300 μm to about 600 μm.

19. The electronic apparatus of claim 18, wherein:
the first hard film has a high temperature modulus ranging from about 2 GPa to about 10 GPa and a thickness ranging from about 75 μm to about 150 μm, and
the soft film has a high temperature modulus of about 1 GPa or lower, a thickness ranging from about 50 μm about 150 μm, and a recovery force of about 90% or more.

20. The electronic apparatus of claim 18, wherein:
the first hard film comprises a resin film, and
the second hard film comprises a thin-glass film.
